(19) United States
(12) Patent Application Publication
(10) Pub. No.: US 2004/0129375 A1
(43) Pub. Date: Jul. 8, 2004

(54) Continuous filament mat binder system

(76) Inventors: Adrian C. Lane, Alexandria, PA (US); Jeffrey L. Antle, Amarillo, TX (US)

Correspondence Address: OWENS CORNING, 2790 COLUMBUS ROAD, GRANVILLE, OH, 43023, US

(21) Appl. No.: 10/712,755

(22) Filed: Nov. 13, 2003

Related U.S. Application Data
(63) Continuation of application No. PCT/US03/14933, filed on May 12, 2003.
(60) Provisional application No. 60/380,350, filed on May 13, 2002.

(30) Foreign Application Priority Data
May 12, 2003 (WO) PCT/US03/14933

(51) Int. Cl. B32B 31/00

(52) U.S. Cl. 156/181; 524/524

(57) ABSTRACT

A binder slurry (24) for a continuous filament mat (50) used in a phenolic pultrusion system comprising a phenolic compatible silane, a non-ionic surfactant, a defoamer, water, an organic acid and a polyvinyl acetate copolymer binder. The binder slurry resin is unique in that the polyvinyl acetate copolymer binder is compatible with presently available phenolic resins, and as such pultruded parts made have improved surface and mechanical properties as compared with traditional polyester type binder slurries which are not compatible with phenolic resins.

### TECHNICAL FIELD AND INDUSTRIAL APPLICABILITY OF THE INVENTION

The present invention relates generally to continuous filament mats and more specifically to a binder system for a continuous filament mat.

### BACKGROUND OF THE INVENTION

Continuous filament mats are widely known and are used as one component in fiber reinforced composite parts.

To make a fiber reinforced phenolic resin part having a continuous filament mat, the continuous filament mat must first be produced. Traditionally, the continuous fiber mat is produced by first introducing a sizing to the continuous glass fiber by known methods. A polyester binder system is then introduced to the sized fiber using a curtain coater or some similar technique to flood the glass fiber. The flooded sized fiber is then dried in an oven to form the continuous filament mat. The mat and a glass roving(s) are then subsequently wetted with a phenolic resin, typically by running the mat and roving through a phenolic resin bath. The wetted mat and glass roving are then introduced into a heated pultrusion die. The die shapes the mat and glass roving into a resin/glass composite that is then cured to form a pultruded part.

One problem with known methods is that the polyester binder materials used to form the continuous filament mats are not fully compatible with the phenolic resins that form the resin matrix. This affects the performance of the composite part.

It is thus highly desirable to make a binder system that is fully compatible with the phenolic resin bath, thereby forming fiber reinforced phenolic resin composite parts having potentially superior performance characteristics.

### SUMMARY OF THE INVENTION

One object of the invention is to make a binder system that is fully compatible with the phenolic resin bath, thereby forming fiber reinforced phenolic resin composite part having potentially superior performance characteristics.

The present invention uses a powdered bisphenol epoxy with a thermally active crosslinking agent (dicyandiamide) dispersed into a flooding liquid preferably having a non-ionic surfactant, a silane, a defoaming agent, and water. An organic acid is also added for pH control. The powder binder and flooding liquid act as a system to bind the multiplicity of glass fibers into a mat. As the powdered bisphenol epoxy and thermally active crosslinking agent are compatible with the phenolic resin, as compared with traditional unsaturated polyester binder systems which are not compatible, pultruded parts having improved performance characteristics are realized.

In addition, the continuous filament mat formed in the above process could also be used in an epoxy application using a prepreg type process to form a laminate material that could be subsequently press molded to form a composite laminate part.

Other objects and advantages of the present invention will become apparent upon considering the following detailed description and appended claims, and upon reference to the accompanying drawings.

### BRIEF DESCRIPTION OF THE DRAWINGS

FIG. 1 is a schematic diagram of a process for making a continuous filament mat according to a preferred embodiment of the present invention;

FIG. 2 is a schematic diagram for making a pultruded composite part from the continuous filament mat of FIG. 1 according to a preferred embodiment of the present invention; and

FIG. 3 is a schematic diagram for making an epoxy prepreg tape from the continuous filament mat of FIG. 1 according to another preferred embodiment of the present invention.

FIG. 4 is a schematic diagram depicting a urethane resin injection system according to another preferred embodiment of the present invention.

### DETAILED DESCRIPTION OF THE INVENTION

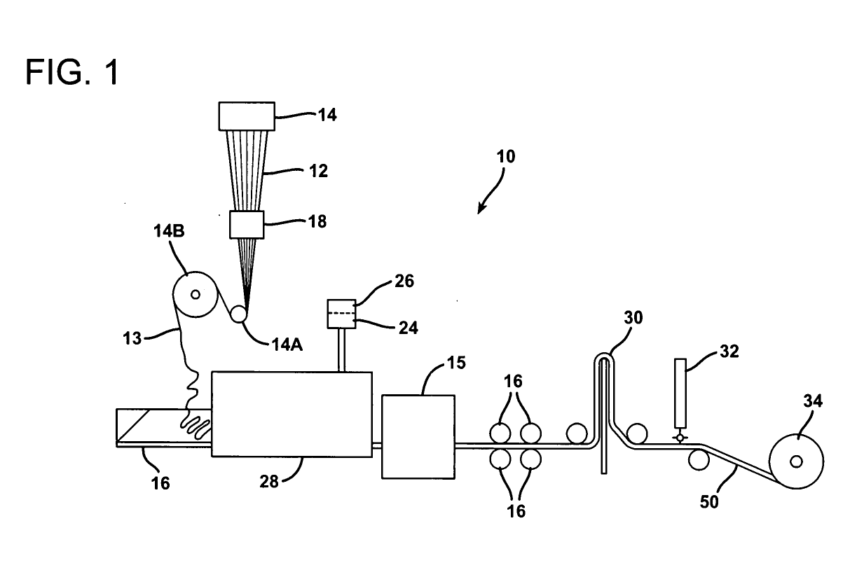

Referring now to FIG. 1, a preferred assembly process for forming a continuous filament mat 50 is generally shown as 10. One or more strands of a continuous filament fiber 12 are formed in a furnace 14 by melting a quantity of glass or other reinforcing material, typically in the form of marbles, in a manner that is well known in the art. A sizing composition 18 is introduced to the one or more strands of fiber 12. The sizing composition 18 preferably contains a phenolic compatible silane and a lubricant that is introduced to the fiber 12 by roll application, dipping, flooding or by any other method that is known in the art. A preferred composition of the sizing composition 18 is listed below in Table 1.

The sized fibers 12 are then formed together into one continuous strand 13 by a pair of pulleys 14A and 14B. The continuous strand 13 may also be split into a multiple number of bundles or splits (n=2-30), and is hereinafter referred to as continuous strand 13 for ease of description. The continuous strand 13 is placed onto a moving belt 16. The continuous strand 13 is then moved along the moving belt 16 and flooded with continuous filament mat (“CFM”) binder slurry 24. The CFM binder slurry 24 comprises a powdered polymer binder material with a thermally active cross-linking agent dispersed in water with a small percentage of phenolic compatible silane. An antifoaming agent and dispersant are also typically added to the slurry. A preferred composition of the slurry is listed below in Table 2.

The CFM binder slurry 24 that is formed is then delivered from a sump tank 26 to a curtain coater 28 wherein the mixture floods the continuous strand 13. The excess liquid is removed from the strand 13 by suction. The strands 13 are then transferred to an oven 15 for moisture removal and curing and then pressed in a plurality of presses 16 to form a binded filament mat 50. Preferably, the oven 15 is set between approximately 450-520 degrees Fahrenheit. Upon exiting, the binded filament mats 50 are then slit by a slitter 30, cut to a preferred size by a cutter 32, and rolled onto a cardboard tube 34. The binded filament mats 50 rolled onto the cardboard tube 34 are loaded with the CFM binder in a range of 4-8% of the dry total weight of the binder and matting.

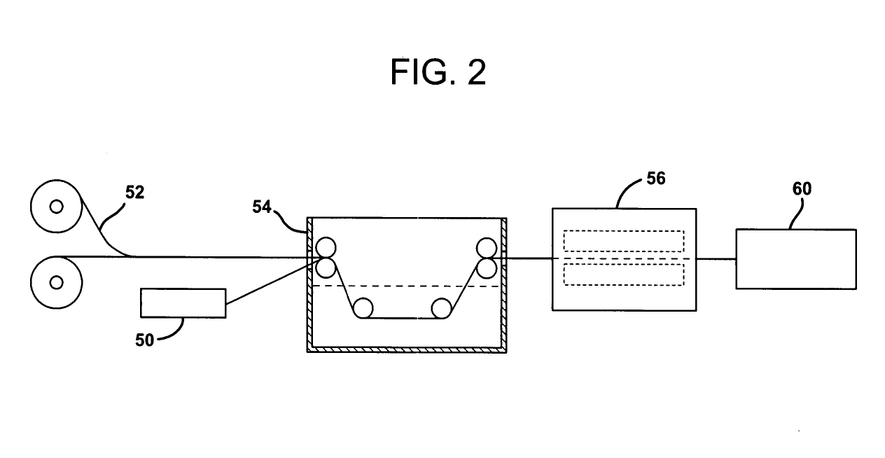

The binded mats 50 that are formed above are then available to be combined with a plurality of glass rovings 52 to form a composite phenolic pultruded part 60. This is depicted in FIG. 2. First, the mats 50 and a plurality of glass rovings 52 are dipped through a phenolic bath 54. The phenolic bath 54 that is used is well known in the art and is compatible with the mats 50 having the CFM binder. For example, one preferred phenolic pultrusion resin for use in the phenolic pultrusion bath 30 is Georgia Pacific's 289D17 phenolic resin.

The mats 50 and rovings 52 are then introduced into a heated pultrusion die 56. The heated pultrusion die 56 cures the resin/glass composite into composite part 60. The time and temperature within the heated pultrusion die 56 are to ensure that the composite part 60 formed is fully cured. Preferably, the temperature within the heated pultrusion die 56 is between approximately 375 and 450 degrees Fahrenheit and the time is sufficient to ensure a fully cured part.

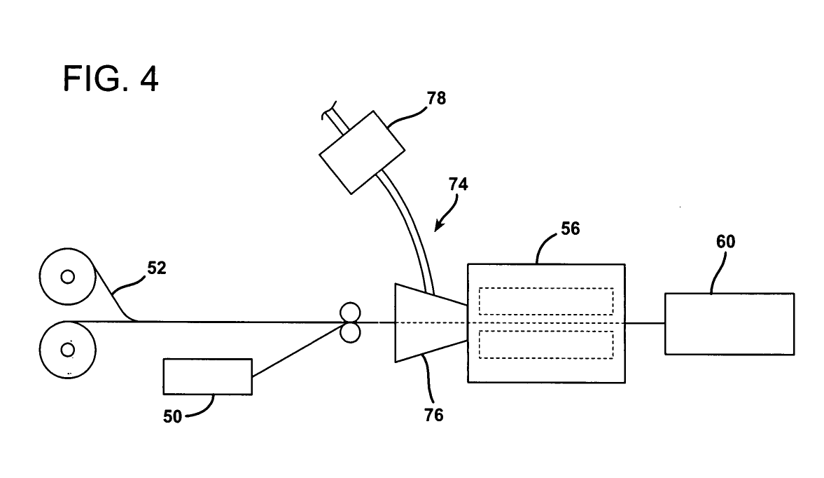

In an alternative embodiment, the phenolic bath 54 may be replaced with a urethane resin injection system 74, as shown in FIG. 4. The urethane resin injection system includes an injector box 76 for injecting resin onto the mats and rovings prior to them entering the pultrusion die 56. Resin is supplied from a resin mixing box 78 which is typically connected to a metering pump (not shown) from which the resin components are fed from one or more supply pumps (not shown).

The urethane resin composition, like the phenolic resin composition, is compatible with the CFM binder contained within the mat 50. The curing temperature for the urethane composite part formed within the heated pultrusion die 56 is typically lower than that of the phenolic composite part 56, with preferred temperatures between approximately 250 and 350 degrees Fahrenheit.

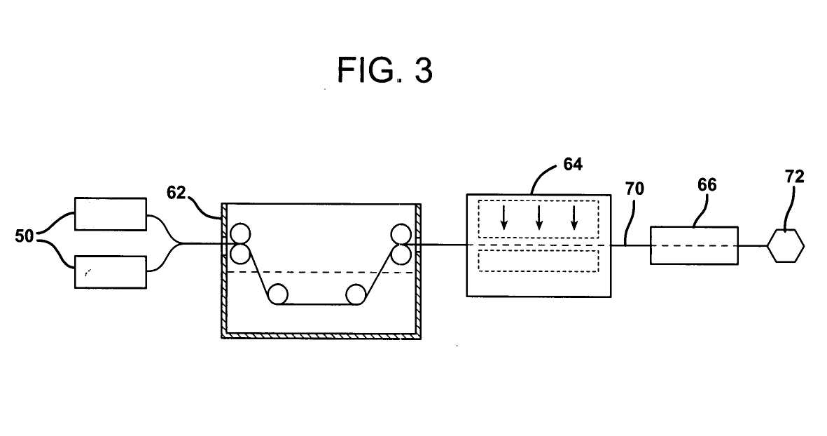

In an alternative preferred embodiment, as shown in FIG. 3, an epoxy type prepreg 70 may be produced from the mats 50 formed above. In this process, the fibers 12 are run through the sizing composition 18 and the CFM slurry bath 24 to form the binded mat 50 as described above in FIG. 1. The mats 50 are then dipped in an epoxy bath 62 and prestaged in an oven 64 to form the epoxy prepreg 70. Preferably, the oven 64 is set for between 300 and 400 degrees Fahrenheit and the line speed is set sufficient to cure the epoxy prepreg, typically around 5-10 minutes. The layers of the epoxy prepreg 70 are then pressed together in a press 66 to form a composite part 72. This composite part 72 may be used in a wide variety of applications such as electrical laminates that are well known in the art.

One preferred example of an epoxy bath 62 that may be used in the present invention is discussed in Tables 1 and 2 of G. A. Hunter's 1988 Article “Pultruding Epoxy Resin”, presented at the 43^{rd} Annual Conference sponsored by The Society of Plastics Industry, Inc., which is herein incorporated by reference.

Mat and Roving Material

The mat 50 material is preferably a continuous filament glass fiber material. This may include s-type glass fibers or e-type glass fibers, and other commercially available glass fibers that are well known in the art. In the preferred embodiment of the present invention, e-type glass is used.

The roving 52 material is also preferably a continuous filament glass fiber material. This may include s-type glass fibers or e-type glass fibers, and other commercially available glass fibers that are well known in the art. In the preferred embodiment of the present invention, e-type glass is used. In addition, the method for making the glass roving material may include any method that is well known in the art.

Sizing Composition

The sizing composition 18 is made by mixing a phenolic compatible silane in water. The pH of the resultant mixture is then adjusted to between 4 and 6 by adding an acid such as acetic acid. One preferred silane that may be used is a gamma-aminopropyl trimethoxy silane such as Witco-OSI's A-1100. At least one lubricant is added to the resultant mixture and the pH is once again adjusted to between 4 and 6 using acetic acid. Two preferred lubricants are Cirrosol 185AE and 185AN, each manufactured by ICI America. Cirrosol 185AE is a octanoic (caprylic) acid-tetraethylene pentamine condensate solubulized with acetic acid, while 185AN is a (pelargonic) acid-tetraethylene pentamine condensate solubulized with acetic acid. A preferred sizing composition 18 is shown below in Table 1:

TABLE 1
SIZING COMPOSITION 18

| MIX | | | | | | |
|---|---|---|---|---|---|---|
| QUANTITY | | | 1000 GALLON | | | |
| MATERIALS | MIN. | | NOM. | | MAX. | |
| First Water | 981 | gal. | 981 | gal. | 981 | gal. |
| Acetic Acid | 15.77 | lbs. | 16.60 | lbs. | 17.43 | lbs. |
| A-1100 Silane | 15.77 | lbs. | 16.60 | lbs. | 17.43 | lbs. |
| Cirrasol 185AE | 1.43 | lbs. | 1.50 | lbs. | 1.58 | lbs. |
| Cirrasol 185AN | 0.67 | lbs. | 0.70 | lbs. | 0.74 | lbs. |
| Water for Cirrasol | 3.6 | lbs. | 4.0 | lbs. | 4.4 | lbs. |
| Water For Acid | 560 | mls. | 650 | mls. | 740 | mls. |
| Acetic Acid for Cirrasol | 340 | mls. | 350 | mls. | 360 | mls. |

CFM Binder Slurry

Current binder materials use unsaturated polyester binders that have shown unacceptable performance in phenolic pultrusion systems. It is believed that the polyester binders do not provide a compatible interface with the phenolic binder resins. The CFM binder system of the present invention solves this problem by providing a compatible interface.

The CFM binder slurry 24 is prepared by dispersing a powdered polymer resin having a thermally active cross-linking agent into the liquid portion of the slurry 24. One preferred powdered polymer resin having a thermally active cross-linking agent is a bisphenol type epoxy resin with a thermally active dicyandiamide cross-linking agent such as Pretex 110, manufactured by Reichold. The powdered polymer is fed at a constant flow rate to deliver the concentration above. This material is fed into a sump tank with high agitation to keep the powder dispersed in the flooding liquid.

One or more non-ionic surfactants are typically added as a dispersant and as a defoamer. Preferably Triton X-100 (Union Carbide, a division of Dow Chemical, Danbury, Conn.) is used as the surfactant and Foamex AD-300 (Rhodia Inc., Cranbury, N.J.) is used as the defoamer. Also, a phenolic compatible silane is added to the resultant mixture. Preferably, this silane is Witco-OSI's A-1100 silane. Finally, the pH is adjusted to between 4 and 6 using acetic acid.

The composition contains the following materials with the preferred ranges: 0 to about 6 percent by weight cross-linking agent; 0 to about 5 percent by weight nonionic surfactant; 0 to about 3 percent by weight acetic acid; 0 to about 3 percent by weight silane; and 0 to about 3 percent by weight defoamer. Water is added to bring the total percent by weight of the composition to 100%.

Table 2 discloses an example of the prepared binder slurry as well as the most preferable ranges of materials added to the binder slurry.

TABLE 2
CFM BINDER SLURRY 24

| | ACTIVE | PERCENT | | |
|---|---|---|---|---|
| | NON- | BY | | |
| | VOLATILE | WEIGHT | | 1000 |
| | SOLIDS AS | AS | | GALLON |
| MATERIAL | RECEIVED | RECEIVED | RANGE | MIX |
| Pretex 110 | 100 | 1.32% | 0.3-2.0% | 110 |
| Triton X-100 | 100 | 0.010% | 0.005-0.02% | 0.8 |
| Acetic acid | | 0.37% | 0.10-0.60% | 30.6 |
| A-1100 | 58 | 0.37% | 0.10-0.60% | 30.6 |
| Foamex AD-300 | 50 | 0.010% | 0.005-0.02% | 0.8 |
| WATER | | 97.93% | | 8157 |
| Total weight | | 100.0% | | 8330 |
| MIX SOLIDS | | | | 1.55% |

Alternatively, another preferred composition of the CFM binder can be used. Surprisingly, it has been determined that a polyvinyl acetate copolymer (PVAC/Silane copolymer) provides a more compatible interface for phenolic resin systems. The PVAC is added prior to the delivery to the sump tank.

In the present invention, Vinamul 25-1037 PVAC copolymer (Vinamul Polymers, Woodruff, S.C.) is preferably used. Other alternative compositions include QRXP 1629A (Rohm & Haas, Philadelphia, Pa.), a polycarboxylic acidlpolyhyrdric alcohol and Vinamul 25-028A (Vinamul Polymers, Woodruff, S.C.), a self-crosslinking acrylic copolymer. The composition is made as described above; however, a cross-linking agent is not added. The composition contains the following materials with the preferred ranges: 0 to about 10 percent by weight PVAC copolymer; 0 to about 5 percent by weight nonionic surfactant; 0 to about 3 percent by weight acetic acid; 0 to about 3 percent by weight silane; and 0 to about 3 percent by weight defoamer. Water is added to bring the total percent by weight of the composition to 100%.

Table 3 discloses an example of the prepared binder slurry as well as the most preferable ranges of materials added to the binder slurry.

TABLE 3
CFM BINDER SLURRY

| | ACTIVE | PERCENT | | |
|---|---|---|---|---|
| | NON- | BY | | |
| | VOLATILE | WEIGHT | | 1000 |
| | SOLIDS AS | AS | | GALLON |
| MATERIAL | RECEIVED | RECEIVED | RANGE | MIX |
| Vinamul 25-1037 | 56 | 2.36% | 0.6-4.0% | 196 |
| Triton X-100 | 100 | 0.010% | 0.001-0.05% | 0.8 |
| Acetic acid | | 0.37% | 0.10-0.60% | 30.6 |
| A-1100 | 58 | 0.37% | 0.10-0.60% | 30.6 |
| Foamex AD-300 | 50 | 0.010% | 0.005-0.05% | 0.8 |
| WATER | | 97.93% | | 8157 |
| Total weight | | 100.0% | | 8330 |
| MIX SOLIDS | | | | 1.55% |

While the invention has been described in terms of preferred embodiments, it will be understood, of course, that the invention is not limited thereto since modifications may be made by those skilled in the art, particularly in light of the foregoing teachings.

What is claimed is:

1. A CFM binder slurry (24) for a continuous filament mat (50) used in a phenolic pultrusion system comprising:
a phenolic compatible silane; and
a polyvinyl acetate copolymer binder.

2. The CFM binder slurry of claim 1 further comprising a non-ionic surfactant, a defoamer, water and an organic acid.

3. The CFM binder slurry of claim 2, wherein said organic acid is acetic acid and wherein the pH of the CFM binder slurry is maintained between approximately 4 and 6.

4. The CFM binder slurry of claim 1, wherein said phenolic compatible silane comprises a gamma-aminopropyl trimethoxy silane.

5. A method for making a continuous filament mat (50), the method comprising the steps of:
providing at least one continuous filament fiber (12);
applying a sizing composition (18) to each of said at least one continuous filament fibers;
forming said at least one continuous filament fiber into a continuous fiber strand (13);
applying a CFM binder (24) to said continuous fiber strand, said CFM binder comprising a phenolic compatible silane and a polyvinyl acetate copolymer binder; and
drying and curing (15) said CFM binder on said continuous fiber strand;
pressing (16) said continuous fiber strand having said CFM binder to form the continuous filament mat.

6. The method of claim 5, wherein said dried CFM binder comprises between 4 and 8% of the total weight of said continuous filament mat.

7. The method of claim 5, wherein said at least one continuous filament fiber comprises at least one continuous e-type glass filament fiber.

8. The method of claim 5, wherein the pH of said sizing composition and said CFM binder slurry is between approximately 4 and 6.

9. A method for forming a pultruded composite part (60) comprising the steps of:
applying a sizing composition (18) to at least one continuous filament fiber (12);
forming said at least one continuous filament fiber into a continuous fiber strand (13);
applying a CFM binder (24) to said continuous fiber strand, said CFM binder comprising a phenolic compatible silane and a polyvinyl acetate copolymer binder; and
drying and curing (15) said CFM binder on said continuous fiber strand;
pressing (16) said continuous fiber strand having said CFM binder;
slitting (30) said continuous filament mat to a desired size and shape to form a continuous filament mat (50);
pulling at least one of said continuous filament mats and at least one continuous filament roving (52) through a phenolic resin bath (54); and
molding and curing said continuous filament mat and said at least one continuous fiber roving within a heated pultrusion die (56) to form the pultruded composite part.

10. The method of claim 9, wherein said first amount of said dried CFM binder comprises between 4 and 8% of the total weight of said at least one continuous filament mats.

11. The method of claim 9, wherein said at least one continuous filament fiber comprises at least one continuous e-type glass filament fiber.

12. The method of claim 9, wherein the pH of said sizing composition and said CFM binder slurry are between approximately 4 and 6.

13. A method for forming a pultruded composite part (60) comprising the steps of:
applying a sizing composition (18) to at least one continuous filament fiber (12);
forming said at least one continuous filament fiber into a continuous fiber strand (13);
applying a CFM binder (24) to said continuous fiber strand, said CFM binder comprising a silane and a polyvinyl acetate copolymer binder; and
drying and curing (15) said CFM binder on said continuous fiber strand;
pressing (16) said continuous fiber strand having said CFM binder;
slitting (30) said continuous filament mat to a desired size and shape to form a continuous filament mat (50);
pulling at least one of said continuous filament mats and at least one continuous filament roving (52) through a urethane resin injection system (74); and
molding and curing said continuous filament mat and said at least one continuous fiber roving within a heated pultrusion die (56) to form the pultruded composite part.
